(19) United States
(12) Patent Application Publication
(10) Pub. No.: US 2021/0357955 A1
(43) Pub. Date: Nov. 18, 2021

(54) USER SEARCH CATEGORY PREDICTOR

(71) Applicant: Mercari, Inc., Palo Alto, CA (US)

(72) Inventors: Sahil RISHI, San Jose, CA (US); Manikandan SANKAR, Hayward, CA (US); Byong Mok OH, Los Altos, CA (US); Yodhavee CHUENBUNLUESOOK, Bangkok (TH); Shuichi IIDA, San Mateo, CA (US); Jeffrey Kenichiro HARA, Santa Clara, CA (US); Stephen JOHNSON, Tokyo (JP)

(21) Appl. No.: 17/302,581

(22) Filed: May 6, 2021

Related U.S. Application Data
(60) Provisional application No. 63/023,298, filed on May 12, 2020.

(51) Int. Cl. G06Q 30/02; G06F 16/957; G06F 17/18

(52) U.S. Cl. CPC G06Q 30/0201; G06F 17/18; G06F 16/957

(57) ABSTRACT

Described herein are embodiments for improving search engine results of listings of For Sale Objects (FSOs). A search engine may be improved by implementing rules that resolve ambiguity between listings for different (FSOs) that match the same search inputs. An unsupervised machine learning module may evaluate candidate rules and identify improvements that may not be obvious to a human evaluator. An ecommerce site that combines the improved search engine with the unsupervised machine learning module may dynamically evaluate search results using different candidate rules and iteratively improve search results.

### TECHNICAL FIELD

This disclosure relates generally to testing and incorporating rules into search methods that improve search results.

### BACKGROUND

Ecommerce web sites and applications provide buyers with the means for purchasing a variety of goods. However, searches of these goods may often result in ambiguity in search results. Buyers may attempt to minimize their input or may search for a For Sale Object (FSO) listing in a way that ambiguously conveys buyer intent. Different FSOs may have characteristics or names that match to similar search terms. Search results may be replete with useless listings of FSOs or may even not contain listings of FSOs that a buyer is seeking, despite the presence of those listings in the ecommerce site.

### BRIEF SUMMARY

Provided herein are system, apparatus, article of manufacture, method and/or computer program product embodiments, and/or combinations and sub-combinations thereof, for improving search engine results in ecommerce sites by testing rules that reduce ambiguity in search inputs, identifying which rules are effective, and implementing those rules in the ecommerce site.

Some embodiments operate by: providing a control group of buyers with baseline search results based on a search input and current rules; providing test groups of buyers with filtered search results based on the search input, current rules, and a candidate rule corresponding to a specific test group; receiving control responses from the control group of buyers and test responses from the test groups of buyers; and, for each test group:

determining a metric based on the control response and the test response for the test group; in response to the metric being statistically significant and less than a threshold, discarding the candidate rule corresponding to the test group; and in response to the metric being statistically significant and greater than the threshold, adding the candidate rule corresponding to the test group to the current rules.

Some embodiments operate by: receiving a search input from buyers, assigning each buyer to a group, wherein the groups comprise a control group and groups, each test group corresponding to a candidate rule; identifying search results from FSO listings based on the search input; filtering the search results based on current rules to identify first filtered search results; for each test group, filtering the search results based on the current rules and a corresponding candidate rule that corresponds to the test group to identify filtered search results corresponding to the test group; providing the first filtered search results of the control group; for each test group, providing the filtered search results corresponding to the test group; receiving response indicators from the buyers; determining a performance metric for each test group based on the response indicators; determining a statistical significances for each test group based on the performance metrics; for each test group, in response to the statistical significance for the test group being greater than a threshold in response to the performance metric for the test group being less than a metric threshold, discarding the candidate rule corresponding to the test group from the candidate rules; and in response to the performance metric for the test group being greater than the metric threshold, adding the candidate rule corresponding to the test group to the current rules.

Further embodiments, features, and advantages of the present disclosure, as well as the structure and operation of the various embodiments of the present disclosure, are described in detail below with reference to the accompanying drawings.

### BRIEF DESCRIPTION OF THE DRAWINGS/FIGURES

The accompanying drawings, which are incorporated herein and form a part of the specification, illustrate embodiments of the present disclosure and, together with the description, further serve to explain the principles of the disclosure and to enable a person skilled in the art(s) to make and use the embodiments.

FIG. 1 illustrates a block diagram of a computing environment for an ecommerce site where users can search for items to buy, including a search engine capable of dynamic improvement, according to some embodiments

FIG. 2 is a flow chart illustrating a method for testing a candidate rule for improving search engine results, according to some embodiments.

FIG. 3 illustrates a block diagram of a general-purpose computer that may be used to perform various aspects of the present disclosure, according to some embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, article of manufacture, method and/or computer program product embodiments, and/or combinations and sub-combinations thereof, for improving search engine results in ecommerce sites by testing rules that reduce ambiguity in search inputs, identifying which rules are effective, and implementing those rules in the ecommerce site.

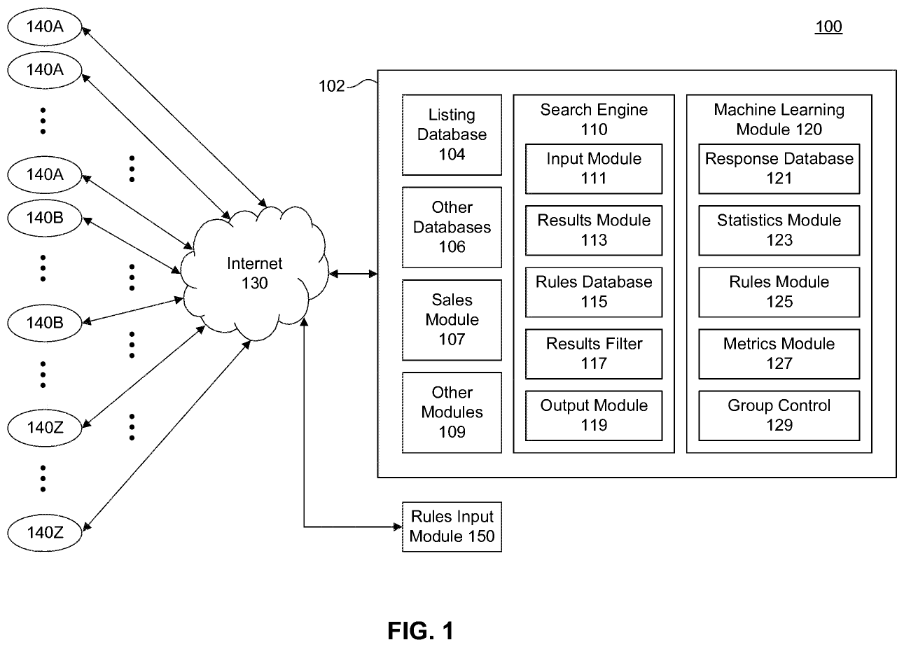

FIG. 1 illustrates a block diagram of a computing environment 100 that includes an ecommerce site 102 where buyers 140 can browse, search, and buy items and services being offered for sale (herein referred to as For Sale Objects, or FSOs), according to some embodiments. The buyers 140 can access the ecommerce site 102 via the Internet 130 or any other network or communication medium, standard, protocol, or technology.

The ecommerce site 102 has a listing database 104 that contains listings of FSOs that buyers 140 can search using search engine 110. Once a buyer 140 has found a desired listing, the buyer 140 can choose to purchase the FSO in the desired listing through sales module 107.

Ecommerce site 102 has a machine learning module 120 that can monitor the interactions of buyers 140 with ecommerce site 102 and modify search engine 110, according to some embodiments. Ecommerce site 102 also contains other databases 106 for storing data and other modules 109 for performing functions related to the ecommerce site 102.

Search engine 110 can receive search inputs from buyers 140 from input module 111, and search the listing database 104 for listings that match the search inputs using results module 113. The results module 113 identifies search results and may provide them to output module 119, according to some embodiments. Output module 119 may provide the search results to buyers 140.

In some embodiments, search engine 110 has a rules database 115, which contains rules for filtering the search results. A rule may be a set of conditions or parameters for adding or removing listings from the search results. In some embodiments, the rule may be configured to resolve ambiguity in the search inputs to filter undesired results from the search results. In some embodiments, the rule may be configured to boost specific results so that they appear higher or earlier in the overall results. The results may be boosted based on an attribute that is related to the result. In some embodiments, the rule may rank the results based on the item having or not having one or more attributes.

Results filter 117 and rules database 115 may operate together to filter search results based on the search inputs and rules. For example, results filter 117 may apply the rules from the rules database 115 to filter the search results and remove results that do not satisfy a rule. As another example, results filter 117 may provide the rules from rules database 115 to results module 113 to cause results module 113 to only identify search results from listings that satisfy the provided rules. As yet another example, results filter 117 may apply the rules to the listings in the listing database 104 to identify filtered listings, which results module 113 may then search to identify the search results. As yet another example, results filter 117 may apply rules from rules database 115 to emphasize or boost a specific result so it appears first in the search results.

For example, a search input of “IPHONE” may match to listings of both IPHONES and IPHONE cases. This is an ambiguity introduced by the search input, as a buyer 140 might input “IPHONE” to search for either object. This ambiguity could be resolved by the buyer 140 inputting additional information, such as adding the word “case” to the search input. An example rule may resolve this ambiguity by differentiating between listings for IPHONES and accessories, such as cases. The rule may do this by differentiating between categories that distinguish between IPHONES and IPHONE accessories. The rule may be that, for an input of “IPHONE,” IPHONE accessories should be excluded. In other words, the rule may be that, for an input of “IPHONE,” the category of accessories should excluded.

As another example, a rule could boost or emphasize “IPHONE” over “IPHONE CASE” as results. The search results would then place any “IPHONE” search results ahead of “IPHONE CASE” search result.

In some embodiments, machine learning module 120 dynamically tests candidate rules to identify new rules for integration into the rules database 115. Candidate rules may resolve potential or known ambiguities in search inputs. Group control 129 may control which buyers 140 are used to dynamically test the candidate rules by providing candidate rules from the rules module 125 to the rules database 115 or rules results filter 117. Results filter 117 may use the candidate rules to filter search results, including in combination with existing rules in the rules database 115. Group control 129 may configure output module 119 to provide the filtered search results to specified groups of buyers 140.

Ecommerce site 102 may monitor the responses of buyers 140 to search results provided by output module 119. Response database 121 may store information about those responses, statistics module 123 may perform statistical analysis on those responses, and metrics module 127 may calculate metrics of the responses. Machine learning module 120 may determine if a candidate rule is effective in resolving an ambiguity based on the statistical analysis and metrics. If a candidate rule is effective, machine learning module 120 may add that rule to the rules database 115 to be used in filtering of search results. If the candidate rule is not effective, machine learning module 120 may discard that rule.

Machine learning module 120 may generate candidate rules using rules module 125 based on identified or perceived ambiguities in search inputs or results. The candidate rules may be generated for the purpose of attempting to improve search results identified or generated by search engine 110. Machine learning module 120 may also receive candidate rules from rules input module 150 through the internet 130, or through other sources.

In some embodiments, rules input module 150 can be incorporated into ecommerce site 102. For example, rules input module 150 may be incorporated in machine learning module 120 or other modules 109.

In some embodiments, machine learning module 120 can conduct dynamic testing of candidate rules on subsets of buyers 140. Group control 129 may divide buyers 140 into groups, such as buyers 140A, buyers 140B, and so on, to buyers 140Z. Machine learning module 120 may use a group of buyers 140, such as buyers 140A, as a control group that only receives search results without filtering or with filtering based on current rules in rules database 115, but not candidate rules. Machine learning module 120 may use other groups of buyers 140, such as buyers 140B or 140Z, as test groups that receive search results filtered by candidate rules or current rules in combination with candidate rules. Each test group may be associated with a specific candidate rule.

Machine learning module 120 may use a control group and test groups of buyers 140 to provide comparison of buyer responses to search results from both a baseline search results and search results filtered using candidate rules. Statistical analysis and metrics may be performed on the buyer responses, as discussed above, and as further discussed below, based on these comparisons.

Machine learning module 120 may perform unsupervised learning, whereby machine learning module 120 gathers data and processes such data as it is received. Through this process, machine learning module 120 may advantageously identify and implement rules for improving search results independent of human input. The rules that machine learning module 120 identifies may not be obvious to human observers, but machine learning module 120 may identify those rules as effective by employing methods, such as embodiments of method 200 described below, for evaluating rules to determine which rules improve search results for buyers.

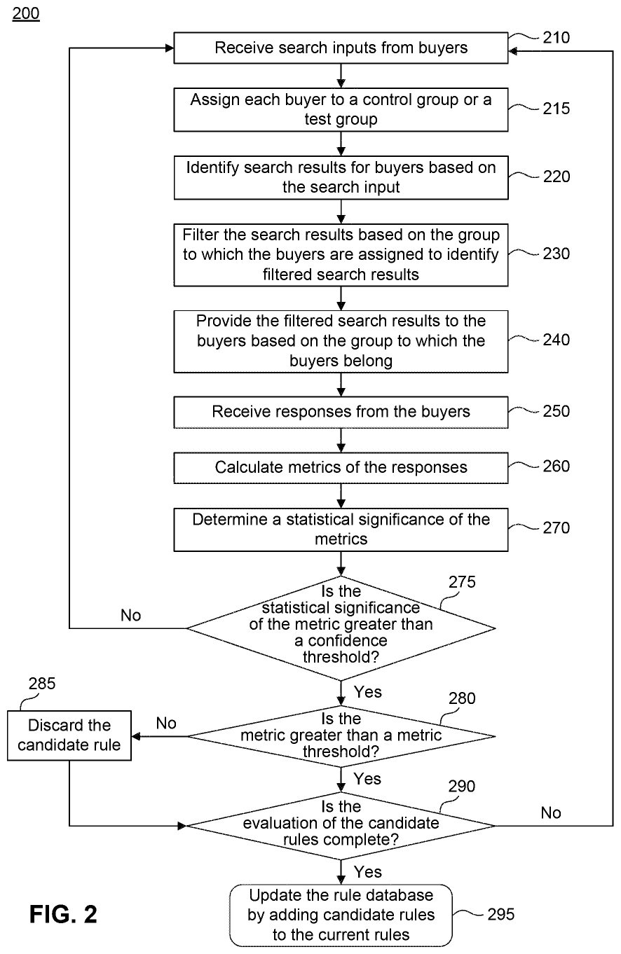

FIG. 2 is a flowchart illustrating a method 200 for testing a candidate rule for improving search engine results, according to some embodiments. Method 200 may be performed by processing logic that may include hardware (e.g., circuitry, dedicated logic, programmable logic, microcode, etc.), software (e.g., instructions executing on a processing device), or a combination thereof. The steps of method 200 may be performed by the ecommerce site 102, described above. Steps of method 200 may be performed by modules and engines in ecommerce site 102 as described above, and as is made more clear in the description of the steps below. A subset of steps of method 200 may be sufficient in order to perform the enhanced techniques disclosed herein. Further, some steps of method 200 may be performed simultaneously, or in a different order from that shown in FIG. 2, as will be understood by a person of ordinary skill in the art.

In some embodiments, ecommerce site 102 provides communication between modules, databases, and engines contain in the ecommerce site 102. Ecommerce site 102 may receive inputs through internet 130 and provide the inputs to the modules, databases, and engines described above. Ecommerce site 102 may send data through internet 130 to buyers 140.

In 210, input module 111 receives search inputs from buyers 140. For example, the search inputs may be received by the ecommerce site 102 and provided to input module 111 of search engine 110.

In some embodiments, the search inputs are strings of characters that describe an FSO that buyers 140 are searching for in listings of the listing database 104. The search inputs may be entered into a user interface on a web site or application running on ecommerce site 102. The search inputs may include search constraints, such as Boolean operators, search category selections, or other constraints.

In some embodiments, the search inputs received from each a given buyer 140 for a given FSO are the same. For example, the search inputs received from a given buyer for an APPLE IPHONE is the same string of characters whenever that buyer searches for that particular FSO.

In 215, group control 129 assigns each buyer 140 to a control group or a test group. A test group corresponds to a candidate rule for improving search results. There may be more than one test group, and each test group corresponds to a different candidate rule. For example, buyers 140A may be a control group, while buyers 140B and so on to buyers 140Z are tests groups. The control group and tests groups may or may not contain the same number of buyers 140.

In some embodiments, a buyer 140 may provide the same search input more than once. For example, a buyer 140 may repeat a search at a later time. In this case, the buyer 140 would have already been assigned to a group by group control 129 in 214. When group control 129 attempts to assign a buyer 140 to a group, if the buyer 140 already belongs to a group, group control 129 does not assign the buyer 140 to a new group, but instead assigns the buyer 140 to the previously assigned group.

In 220, results module 113 identifies search results for the buyers 140 based on the search inputs. Results module 113 may receive the search inputs from input module 111 and use a searching algorithm to search listing database 104, or subsets thereof, for listings that match or correspond to the search inputs and identify them as search results. Ecommerce site 102 may store these search results in other databases 106 for a given search input. Search results may be identified by accessing stored search results that match a search input.

In 230, results filter 117 filters search results based on the group to which the buyers 140 belong to identify filtered search results. Results filter 117 may access or use both the current rules from rules database 115 and candidate rules from rules module 125. For buyers 140 in the control group, results filter 117 filters may use the current rules. For buyers 140 in a test group, results filter 117 filters may use the current rules and the candidate rule corresponding to the test group of the buyer 140. Step 230 may identify different filtered search results for the control group and each test group. Ecommerce site 102 may store each of the filtered search results in other databases 106. The filtered search results may be identified by accessing the stored filtered search results for the same inputs and rules.

Rules in the current rules and candidate rules may filter based on a variety of parameters contained in both the search inputs and the listings. For example, for a given search input, a listing parameter may be preferred, and only listings containing that parameter may be included. As another example, for a given search input, a listing parameter may be boosted and will be listed with a higher score or preference than other listings. As a non-limiting example, a rule may be that a search of “IPHONE” corresponds to the category “smart phone” and the rule will filter out listings that do not contain this category while identifying listings that do. As another non-limiting example, a rule may be that a search of “IPHONE” corresponds to the category “smart phone” and the rule will boost listings that do contain this category above other listings that do not.

In some embodiments, steps 220 and 230 may be performed in different orders than that shown in the example of FIG. 2. For example, as discussed above, step 220 identifies search results and step 230 filters the search results using rules. This approach can be advantageous when the filtering step is more costly in computer cycles or resources than the searching step, as the searching step reduces the number of listings to filter. In another example, step 230 filters the listings stored in listing database 104 using the rules and step 220 searches the filtered listings. This approach can be advantageous when the searching step is more costly in computer cycles or resources than the filtering step, as the filtering step reduces the number of listings to be searched.

In 240, output module 119 provides the filtered search results to buyers 140 based on the group to which the buyers 140 belong. A buyer 140 in the control group receives the filtered search results based on the current rules. A buyer 140 in a test group receives the filtered search results based on the current rules and the candidate rule corresponding to the test group. The filtered search results may be provided to buyers 140 through internet 130.

In step 250, ecommerce site 102 receives responses from buyers 140. Ecommerce site 102 may store the responses in response database 121 or in other databases 106 and provide response database 121 with an indicator of what response was received or details of the response, such as a price paid for a purchased FSO. Machine learning module 120 may retrieve the response indicator from the other databases and store it in response database 121.

In some embodiments, a response is an action taken by a buyer 140 based on the filtered search results provided. Example responses include, but are not limited to:
The buyer 140 selects a listing in the filtered search results.
The buyer 140 chooses to put an FSO in the listing in a checkout system, such as an online shopping cart.
The buyer 140 purchases the FSO within a period of time, such as thirty days.
The buyer 140 does not purchase the FSO in the shopping cart with a period of time.
The buyer 140 selects to view more than one listing in the filtered search results.
The buyer 140 enters a modified or different search, indicating that the buyer 140 did not select any of the listings in the filtered search results.
The buyer 140 closes a browser, window, tab, or application running ecommerce site 102, indicating that the buyer 140 did not select any of the listings in the filtered search results.

In some embodiments, ecommerce site 102 receives more than one response from a single buyer 140. For example, a buyer 140 may view several listings and purchase an FSO from one of those listings, which may generate multiple responses. Step 250 may receive multiple responses over time or at the same time.

In 260, metrics module 127 calculates metrics of the responses. Metrics module 127 may calculate metrics for the control group and each test group, or a subset of the groups. Metrics module 127 may calculate a single metric or several different metrics. Metrics module 127 may combine metrics, including using a weighted combination. The weighting in a weighted combination may be set based on a relative ranking of the different metrics in providing information about the candidate rule's effectiveness in reducing the ambiguity between the search results and the filtered search results.

A metric of the responses may be Gross Merchandise Volume (GMV). Metrics module 127 may determine or calculate GMV for the control group as a sum-total of the cost of items sold to buyers 140 in the control group in response to the search results. The GMV may be calculated for the test group as a sum-total of the cost items sold to buyers in response to the filtered search results.

A metric of the responses may be a view rate. In the control group, metrics module 127 may determine or calculate view rate as the number of buyers 140 who receive an FSO listing in the filtered search results and select to view the FSO listing. In the test group, metrics module 127 may determine or calculate view rate as the number of buyers 140 who receive an FSO listing in the filtered search results and select to view the FSO listing.

A metric of the responses may be a sell through rate. For the control group, metrics module 127 may determine or calculate sell through rate as a number of a specific type of FSOs purchased by buyers 140 in the control group divided by the number of FSO listings containing the specific type of FSOs in the filtered search results. For the test group, metrics module 127 may calculate sell through rate as a number of a specific type of FSOs purchased by buyers 140 in the test group divided by the number of FSO listings containing the specific type of FSOs in the filtered search results.

A metric of the responses may be a click-through rate (CTR) at rate k. Metrics module 127 may determine or calculate CTR at rate k as the percentage of people who clicked on an item in the top k results. For example, for CTR at rate 36, 100 people look at the results and 32 people click on a result in the top 36 results, then CTR at rate 36 is 32%. In some embodiments, the rate k is 3, 6, 12, 18, 36, or other values.

CTR at rate k may identify search results that are more useful or desirable to a user. In some embodiments, CTR at rate k is used to identify results to boost or rank more highly as part of the filtering performed other steps of method 300. In some embodiments, the results identified by CTR at rate k are used to identify common item attributes that have high CTR at rate k (such as over 50%, over 75%, or some other threshold). Items with these attributes may then be boosted or ranked more highly. In some embodiments, CTR at rate k is used to create a rule for boosting or ranking items or item attributes.

As an example of a combined metric, a metric may be a vote of GMV, view rate, and sell through. If two or more of the metrics are higher for the test group than the control group, the metric may be set to a value that represents that the candidate rule is effective. If two or more of the metrics are higher for the control group than the test group, the metric may be set to a value that represents that the candidate rule is ineffective. This combination may be weighted, as discussed above, such that some of the votes count for more than the others.

In 270, statistics module 123 determines a statistical significance of the metrics. Each metric indicates that a candidate rule is or is not improving results, based on a comparison to metric threshold. Metrics module 127 may perform a comparison of the metrics to the metric threshold to determine what the metric indicates. Metrics module 127 may provide this indication to the statistics module 123. Based on the indication, statistics module 123 may generate a hypothesis that the candidate rule is performing as indicated.

In some embodiments, statistics module 123 may determine the statistical significance by performing comparison of the metric to a threshold. For example, one or more values may be calculated based on the metric and each may be compared to a respective threshold. The metric is statistically significant when each value is greater than its respective threshold.

As an example, the value determined may be a p-value; that is, statistics module 123 may determine the statistical significance by performing a p-test on the metrics. Statistics module 123 may perform a p-test on the hypothesis that the candidate rule is performing as indicated, including determining a p-value for the hypothesis. As examples, the hypothesis for the p-test may compare results of a test group to the control group, to the control group and other test groups in combination, or to a different test group.

As another example, the gross sales of unfiltered search results may have a value, while the GMV of the filtered results may be some percentage higher. A comparison of the two yields a percentage increase, which indicates the statistical significance of the GMV when the percentage increase is higher than a threshold, such as 30% or 40%. As a specific, non-limiting example, when the GMV is $2000, and the same items sold only $1000 without the filtering, the raw value has increased by 100%. This increase is higher than a threshold of 30%, and is therefore statistically significant.

In some embodiments, the threshold takes into account both the percentage increase and the overall value. For example, if the GMV is $13 and the unfiltered sales value is $10, there is a 30% increase, but the relative increase in actual dollars is small. The threshold may be the percentage increase as well as a dollar increase of greater than some amount, such as $50, $100, $500, $1000, or some other amount.

In 275, statistics module 123 checks if the statistical significance of a metric is greater than a threshold. If the value or values determined in step 270 are greater than their respective thresholds, than the metric is statistically significant. Based on this result, method 200 returns to step 210 to receive search inputs from other buyers 140.

In some embodiments, the threshold may be set or changed based on the number of remaining candidate rules. For example, the threshold may increase as the number of candidate rules increases.

In 280, metrics module 127 checks whether the metric is greater than the metric threshold. The metric threshold may be set, as discussed above, to identify whether the candidate rule is improving search results in the test group over the control group of rules, candidate rules in other test groups, or both. The metric, the metric threshold, or both may be scaled or normalized for comparison with each other.

In some embodiments, metrics module 127 checks whether the metric is greater than the metric threshold to determine the hypothesis to be used in step 270. Metrics module 127 may store the result internally, or in other databases 106. When performing step 280, instead of repeating the check, metrics module 127 may access or retrieve the result to check it.

If the metric is less than the metric threshold, the candidate rule is not effective and method 200 proceeds to step 285. In 285, machine learning module 120 discards the candidate rule. Machine learning module 120 may also discard response data stored in the response database for the candidate rule and corresponding test group. Group control 129 may remove the test group corresponding to the candidate rule. Future metric and statistical calculations or determinations performed by machine learning module 120 may no longer include the removed test group. Group control 129 may respond to future searches by buyers 140 from the removed test group by assigning those buyers 140 to other test groups or the control group.

If the metric is greater than the metric threshold, then the candidate rule is effective, and method 200 proceeds to step 290.

In some embodiments, the metric threshold may be set or change based on the number of candidate rules remaining. For example, the metric threshold may increase as the number of candidate rules decreases.

In 290, machine learning module 120 checks whether evaluation of the candidate rules is complete. For example, the evaluation of candidate rules may be complete when the number of remaining candidate rules is below a rule count threshold, when the p-value for all remaining rules is above a p-value threshold, or when all p-values for remaining candidate rules indicate that the hypothesis for that candidate rule is statistically significant.

In some embodiments, machine learning module 120 causes statistics module 123 to update p-tests based on the removal of candidate rules by step 285 to verify if evaluation of candidate rules is complete.

If the evaluation is not complete, method 200 returns to step 210 to receive more search inputs.

If the evaluation is complete, method 200 proceeds to step 295. In 295, machine learning module 120 updates the rules database 115 by adding candidate rules to the current rules. In some embodiments, machine learning module 120 adds the remaining candidate rules in the rules module 125 to the current rules. The added candidate rules may be limited to candidate rules with statistically significant metrics indicating that the candidate rule is effective to the current rules in rules module 125.

In some embodiments, at step 295, machine learning module 120 updates the metrics for the remaining rules. This updating may occur by performing step 260. Machine learning module 120 may check the updated metrics against the metric threshold. This checking may occur by performing step 280. Machine learning module 120 may remove any candidate rules with updated metrics less than the metric threshold and add remaining candidate rules to the current rules in rules module 125.

Those skilled in the art will understand that method 200 may receive different search inputs or responses from different buyers 140 at different times. Ecommerce site 102, search engine 110, and machine learning module 120 may perform various steps of method 200 for different buyers 140, search inputs, or responses at the same or different times. Method 200 may actively perform various steps simultaneously, in serial, or at different times, as needed to address different inputs or processing of the method 200. Steps in method 200, such as discarding a candidate rule, may impact other steps in method 200, as described above, and this may result in updates or changes to how some steps are performed between iterations.

Method 200 may be performed simultaneously and independently for different search inputs. For example, ecommerce site 102 may receive different search inputs from buyers 140 and perform method 200 to improve search results for each different search input. Buyers 140 may be assigned to different control and test groups for each search input that they enter.

Method 200 may be performed for a search input for a given set of candidate rules until all the candidate rules are discarded or until some of the candidate rules are added to the current rules. Discarded candidate rules may be tested again at a later time as part of a different set of candidate rules. The different set of candidate rules may include discarded candidate rules from previous iterations. Those skilled in the art will understand that a candidate rule may change in efficacy over time from being ineffective to being effective, depending on changes in buyer 140 habits or market forces.

Example Computer System

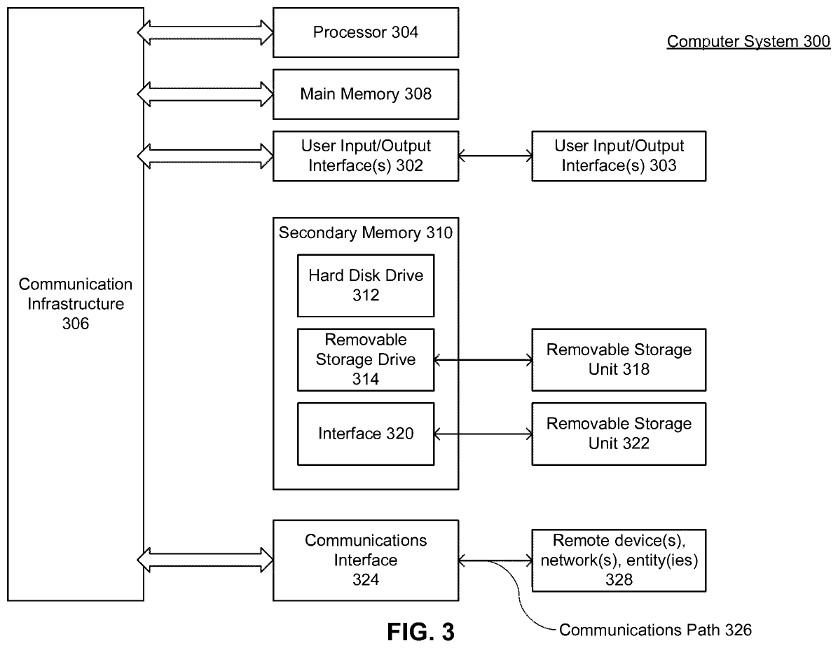

Various embodiments may be implemented, for example, using one or more computer systems, such as computer system 300 shown in FIG. 3. One or more computer systems 300 may be used, for example, to implement any of the embodiments discussed herein, as well as combinations and sub-combinations thereof.

Computer system 300 may include one or more processors (also called central processing units, or CPUs), such as a processor 304. Processor 304 may be connected to a bus or communication infrastructure 306.

Computer system 300 may also include user input/output device(s) 303, such as monitors, keyboards, pointing devices, etc., which may communicate with communication infrastructure 306 through user input/output interface(s) 302.

One or more of processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, vector processing, array processing, etc., as well as cryptography (including brute-force cracking), generating cryptographic hashes or hash sequences, solving partial hash-inversion problems, and/or producing results of other proof-of-work computations for some blockchain-based applications, for example. With capabilities of general-purpose computing on graphics processing units (GPGPU), the GPU may be particularly useful in at least the image recognition and machine learning aspects described herein.

Additionally, one or more of processors 304 may include a coprocessor or other implementation of logic for accelerating cryptographic calculations or other specialized mathematical functions, including hardware-accelerated cryptographic coprocessors. Such accelerated processors may further include instruction set(s) for acceleration using coprocessors and/or other logic to facilitate such acceleration.

Computer system 300 may also include a main or primary memory 308, such as random access memory (RAM). Main memory 308 may include one or more levels of cache. Main memory 308 may have stored therein control logic (i.e., computer software) and/or data.

Computer system 300 may also include one or more secondary storage devices or secondary memory 310. Secondary memory 310 may include, for example, a main storage drive 312 and/or a removable storage device or drive 314. Main storage drive 312 may be a hard disk drive or solid-state drive, for example. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 may read from and/or write to removable storage unit 318.

Secondary memory 310 may include other means, devices, components, instrumentalities or other approaches for allowing computer programs and/or other instructions and/or data to be accessed by computer system 300. Such means, devices, components, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 600 to communicate with external or remote devices 328 over communication path 326, which may be wired and/or wireless (or a combination thereof), and which may include any combination of LANs, WANs, the Internet, etc. Control logic and/or data may be transmitted to and from computer system 600 via communication path 326.

Computer system 300 may also be any of a personal digital assistant (PDA), desktop workstation, laptop or notebook computer, netbook, tablet, smart phone, smart watch or other wearable, appliance, part of the Internet of Things (IoT), and/or embedded system, to name a few non-limiting examples, or any combination thereof.

It should be appreciated that the framework described herein may be implemented as a method, process, apparatus, system, or article of manufacture such as a non-transitory computer-readable medium or device. For illustration purposes, the present framework may be described in the context of distributed ledgers being publicly available, or at least available to untrusted third parties. One example as a modern use case is with blockchain-based systems. It should be appreciated, however, that the present framework may also be applied in other settings where sensitive or confidential information may need to pass by or through hands of untrusted third parties, and that this technology is in no way limited to distributed ledgers or blockchain uses.

Computer system 300 may be a client or server, accessing or hosting any applications and/or data through any delivery paradigm, including but not limited to remote or distributed cloud computing solutions; local or on-premises software (e.g., “on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), database as a service (DBaaS), etc.); and/or a hybrid model including any combination of the foregoing examples or other services or delivery paradigms.

Any applicable data structures, file formats, and schemas may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

Any pertinent data, files, and/or databases may be stored, retrieved, accessed, and/or transmitted in human-readable formats such as numeric, textual, graphic, or multimedia formats, further including various types of markup language, among other possible formats. Alternatively or in combination with the above formats, the data, files, and/or databases may be stored, retrieved, accessed, and/or transmitted in binary, encoded, compressed, and/or encrypted formats, or any other machine-readable formats.

Interfacing or interconnection among various systems and layers may employ any number of mechanisms, such as any number of protocols, programmatic frameworks, floorplans, or application programming interfaces (API), including but not limited to Document Object Model (DOM), Discovery Service (DS), NSUserDefaults, Web Services Description Language (WSDL), Message Exchange Pattern (MEP), Web Distributed Data Exchange (WDDX), Web Hypertext Application Technology Working Group (WHATWG) HTML5 Web Messaging, Representational State Transfer (REST or RESTful web services), Extensible User Interface Protocol (XUP), Simple Object Access Protocol (SOAP), XML Schema Definition (XSD), XML Remote Procedure Call (XML-RPC), or any other mechanisms, open or proprietary, that may achieve similar functionality and results.

Such interfacing or interconnection may also make use of uniform resource identifiers (URI), which may further include uniform resource locators (URL) or uniform resource names (URN). Other forms of uniform and/or unique identifiers, locators, or names may be used, either exclusively or in combination with forms such as those set forth above.

Any of the above protocols or APIs may interface with or be implemented in any programming language, procedural, functional, or object-oriented, and may be compiled or interpreted. Non-limiting examples include C, C++, C#, Objective-C, Java, Scala, Clojure, Elixir, Swift, Go, Perl, PHP, Python, Ruby, JavaScript, WebAssembly, or virtually any other language, with any other libraries or schemas, in any kind of framework, runtime environment, virtual machine, interpreter, stack, engine, or similar mechanism, including but not limited to Node.js, V8, Knockout, jQuery, Dojo, Dijit, OpenUI5, AngularJS, Express.js, Backbone.js, Ember.js, DHTMLX, Vue, React, Electron, and so on, among many other non-limiting examples.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different from those described herein.

References herein to “one embodiment,” “an embodiment,” “an example embodiment,” “some embodiments,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents

What is claimed is:

1. A computer-implemented method for dynamically testing candidate rules for improving search results of listings of For-Sale Objects (FSO) being sold on an ecommerce site, the method comprising:
providing a control group of buyers with baseline search results based on a search input and current rules;
providing test groups of buyers with filtered search results based on the search input, the current rules, and a candidate rule corresponding to a specific test group from the test groups;
receiving control responses from the control group of buyers and test responses from the test groups of buyers; and
for each test group:
determining a metric based on the control response and the test response for the test group;
in response to the metric being statistically significant and less than a threshold, discarding the candidate rule corresponding to the test group; and
in response to the metric being statistically significant and greater than the threshold, adding the candidate rule corresponding to the test group to the current rules.

2. The method of claim 1, wherein the metric is chosen from: gross merchandise volume, sell through, click-through rate at rate k, and view rate.

3. The method of claim 1, wherein the determining the metric comprises combining gross merchandise volume, sell through, click-through rate at rate k, and view rate.

4. The method of claim 3, wherein the combining the gross merchandise volume, the sell through, and the view rate comprises adding gross merchandise volume, sell through, click-through rate at rate k, and view rate in a weighted combination.

5. The method of claim 1, wherein the control responses and the test responses are one or more of: purchasing the FSO, viewing a listing from the first filtered search results or the second filtered search results, entering additional search inputs, or closing the ecommerce site.

6. The method of claim 1, further comprising determining that the metric is statistically significant by:
performing a p-test on a hypothesis based on the metric for each test group to determine a p-value;
comparing the p-value to a p-value threshold; and
in response to the p-value being greater than the p-value threshold, identifying that the metric is statistically significant.

7. The method of claim 1, further comprising determining that the metric is statistically significant by:
calculating one or more values based on the metric; and
comparing each of the one or more values to a respective threshold; and
in response to each of the one or more values being greater than the respective threshold, identifying that the metric is statistically significant.

8. A system for dynamically testing candidate rules for improving search results of listings of For-Sale Objects (FSO) being sold on an ecommerce site, the system comprising:
one or more processors;
one or more network interfaces communicatively coupled to the one or more processors; and
memory communicatively coupled to the one or more processors and the one or more network interfaces, wherein the memory stores instructions that, when executed, cause the one or more processors to:
receive a search input from one or more buyers;
assign each buyer from the one or more buyers to a group from a plurality of groups, the plurality of groups comprising a control group and one or more test groups, each test group corresponding to a candidate rule from one or more candidate rules;
identify search results from a plurality of FSO listings based on the search input;
filter the search results based on current rules to identify first filtered search results;
for each test group from the one or more test groups, filter the search results based on the current rules and a corresponding candidate rule from the one or more candidate rules that corresponds to the test group to identify filtered search results corresponding to the test group;
provide the first filtered search results the control group;
for each test group from the one or more test groups, provide the filtered search results corresponding to the test group;
receive one or more response indicators from the one or more buyers;
determine a performance metric for each test group of the one or more test groups based on the one or more response indicators;
determine a statistical significances for each test group of the one or more test groups based on at least one of the one or more performance metrics; and
for each test group from the one or more test groups, in response to the statistical significance for the test group being greater than a threshold:
in response to the performance metric for the test group being less than a metric threshold, discard the candidate rule corresponding to the test group from the one or more candidate rules; and
in response to the performance metric for the test group being greater than the metric threshold, add the candidate rule corresponding to the test group to the current rules.

9. The system of claim 8, wherein the performance metric is selected from: gross merchandise volume, sell through, click through rate at rate k, and view rate.

10. The system of claim 8, wherein the instructions further cause the one or more processors to determine the performance metric based on the one or more response indicators combining gross merchandise volume, sell through, click-through rate at rate k, and view rate.

11. The system of claim 10, wherein the instructions further cause the one or more processors to combine the gross merchandise volume, the sell through, click-through rate at rate k, and the view rate by a weighted combination.

12. The system of claim 8, wherein the one or more response indicators are one or more of: purchasing the FSO, viewing a listing from the first filtered search results or the second filtered search results, entering additional search inputs, or closing the ecommerce site.

13. The system of claim 8, wherein the instructions further cause the one or more processors to determine the statistical significance for the test group by:
performing a p-test on a hypothesis based on the metric for each test group to determine a p-value;
comparing the p-value to a p-value threshold; and
in response to the p-value being greater than the p-value threshold, identifying that the metric is statistically significant.

14. The system of claim 8, wherein the instructions further cause the one or more processors to determine the statistical significance for the test group by:
calculating one or more values based on the metric; and
comparing each of the one or more values to a respective threshold; and
in response to each of the one or more values being greater than the respective threshold, identifying that the metric is statistically significant.

15. A non-transitory computer readable storage medium having computer readable code thereon, the non-transitory computer readable medium including instructions configured to cause a computer system to perform operations comprising:
receiving a search input from one or more buyers;
assigning each buyer from the one or more buyers to a group from a plurality of groups, the plurality of groups comprising a control group and one or more test groups, each test group corresponding to a candidate rule from one or more candidate rules;
identifying search results from a plurality of FSO listings based on the search input;
filtering the search results based on current rules to identify first filtered search results;
for each test group from the one or more test groups, filtering the search results based on the current rules and a corresponding candidate rule from the one or more candidate rules that corresponds to the test group to identify filtered search results corresponding to the test group;
providing the first filtered search results to the control group;
for each test group from the one or more test groups, providing the filtered search results corresponding to the test group;
receiving one or more response indicators from the one or more buyers;
determining a performance metric for each test group of the one or more test groups based on the one or more response indicators;
determining a statistical significance for each test group of the one or more test groups based on at least one performance metric; and
for each test group from the one or more test groups, in response to the statistical significance for the test group being greater than a threshold:
in response to the performance metric for the test group being less than a metric threshold, discarding the candidate rule corresponding to the test group from the one or more candidate rules; and
in response to the performance metric for the test group being greater than the metric threshold, adding the candidate rule corresponding to the test group to the current rules.

16. The non-transitory computer readable storage medium of claim 15, wherein the performance metric is chosen from: gross merchandise volume, sell through, click-through rate at rate k, and view rate.

17. The non-transitory computer readable storage medium of claim 15, the operations further comprising determining the performance metric based on the one or more response indicators by combining gross merchandise volume, sell through, click-through rate at rate k, and view rate.

18. The non-transitory computer readable storage medium of claim 17, the operations further comprising combining the gross merchandise volume, the sell through, click-through rate at rate k, and the view rate using a weighted combination.

19. The non-transitory computer readable storage medium of claim 15, wherein the one or more response indicators are one or more of: purchasing the FSO, viewing a listing from the first filtered search results or the second filtered search results, entering additional search inputs, or closing an ecommerce site.

20. The non-transitory computer readable storage medium of claim 15, the operations further comprising determining that the metric is statistically significant by:
calculating one or more values based on the metric; and
comparing each of the one or more values to a respective threshold; and
in response to each of the one or more values being greater than the respective threshold, identifying that the metric is statistically significant.
